(19) United States
(12) Patent Application Publication
(10) Pub. No.: US 2026/0145595 A1
(43) Pub. Date: May 28, 2026

(54) RECLINING MECHANISM FOR A SEAT AND SEAT

(71) Applicant: Adient US LLC, Plymouth, MI (US)

(72) Inventors: Sachin Atmaram RANE, Pune (IN); Amol Hemant KENJALE, Pune (IN); Sunil Shankar DAWANDE, Pune (IN); Pravin Rajaram AHIRE, Pune (IN)

(21) Appl. No.: 19/398,230

(22) Filed: Nov. 24, 2025

(30) Foreign Application Priority Data
Nov. 25, 2024 (DE) 10 2024 211 303.4

(51) Int. Cl. B60N 2/20; B60N 2/02

(52) U.S. Cl. CPC B60N 2/20; B60N 2/02246

(57) ABSTRACT

A reclining mechanism for a vehicle seat where the reclining mechanism may have a first fitting which is able to be mounted on a first side of the seat. The mechanism may also have an opposite second fitting which is able to be mounted on a second side of the seat. Each fitting may have at least two fitting parts which are movable with respect to each other. The first fitting may be an actuating fitting for actuating an eccentric swiveling movement between corresponding fitting parts of the first fitting. The second fitting may be a free swivel fitting which may be at least one bushing unit which may couple the corresponding fitting parts of the second fitting in order to enter into an eccentric movement caused by the first fitting.

### FIELD

The invention relates to a reclining mechanism for a seat, in particular a vehicle seat, and to a seat, in particular a vehicle seat, having at least a seat pan frame, a backrest frame, and a reclining mechanism.

### BACKGROUND

The prior art discloses various reclining mechanisms and adjusting devices having fittings for the manually or electrically actuated adjustment of a backrest of a vehicle seat, which has, for example, a swiveling backrest to be adjusted for greater comfort and/or folding backrest for increasing the size of a vehicle rear storage compartment. These are usually used with dual seat back adjuster back frames.

### SUMMARY

One problem of the present invention is to provide an improved reclining mechanism for a seat, in particular a vehicle seat, which is substantially lightweight and provides a compact design such that the reclining mechanism is adaptable to different backrest designs. To implement a simple reclining function of the backrest, in particular only a one-sided actuating fitting is required, which is manually actuable and/or force-actuated. A further problem of the present invention is to provide an improved seat for a vehicle, having an improved reclining mechanism with the aim of achieving the reclining function with only one seat back adjuster rather than the usual two seat back adjusters or a backrest frame with dual seat back adjusters.

The problem relating to the reclining mechanism is solved by the features of claim 1. The problem relating to the seat is solved by the features of claim 9. The reclining mechanism for a seat, in particular a vehicle seat, comprises at least a first fitting which is able to be mounted on a first side of the seat, and an opposite second fitting which is able to be mounted on a second side of the seat, wherein each fitting has at least two fitting parts which are movable with respect to each other. The first fitting is an actuating fitting for actuating a swiveling movement between corresponding fitting parts of the first fitting, wherein the second fitting is a free swivel fitting which comprises at least one bushing unit with which the corresponding fitting parts of the second fitting are coupled in order to enter into an eccentric movement caused by the first fitting.

As a result of the provision of a first fitting, which is an actuating fitting for actuating a swiveling movement between corresponding fitting parts of the first fitting, and the provision of a second fitting, which is a free swivel fitting, which comprises at least one bushing unit with which the corresponding fitting parts of the second fitting are coupled in order to enter into an eccentric movement caused by the first fitting, well-known double-sided force-actuated seat back adjusters can be replaced, with the result that the weight, the number of parts and costs are reduced.

The second fitting is a free swivel fitting, which follows a movement of the backrest when the latter is reclined upon actuation via the first fitting. Since only the first fitting is actuated, an actuation time can be reduced. The first fitting is a one-sided actuating fitting. The first fitting may be a one-sided force-actuated fitting, which is also referred to as a one-sided force-actuated seat back adjuster. The first fitting may optionally be manually actuated. Furthermore, no synchronization, for example via a control unit and/or a coupling rod, is required between the two fittings, thereby reducing costs, installation space, the number of parts, and assembly time, and additionally simplifying the operation of the reclining mechanism.

Existing seat systems can easily be retrofitted with the invention. The reclining mechanism, in particular the fittings thereof, can be adapted easily to conventional seats.

Preferred embodiments of the invention will become apparent from the dependent claims.

The backrest rest frame based on a one-sided actuating fitting has been developed as an innovation in the sector in order to replace the conventional backrest frames based on a double-sided actuating fitting. This is because, as a result, a seat back adjuster together with conventional adaptation mounts per backrest frame are eliminated.

The reclining mechanism, in particular the first and second fitting thereof, may be designed in a modular manner with a backrest frame based on a double-sided and a one-sided manual seat back adjuster in order to provide the further advantage of high design reuse content, resulting in significant savings in terms of costs and expenditure of time in order to introduce product variants elsewhere.

The bushing unit may be an axial bushing. The bushing unit may also be an eccentric, i.e. off-center bushing. The first fitting may be in the form, for example, of a so-called eccentric or off-center joint fitting, wherein the bushing unit can enter into an eccentric or off-center movement caused by the eccentric joint fitting. The bushing unit may be selected, for example, from an axial bushing and an eccentric bushing depending on the actuating mechanism of the first fitting and/or the design of the backrest frame.

The first fitting of the reclining mechanism may be in the form of a rotary fitting, a latch fitting or an eccentric fitting. Only the first fitting may be designed to be actuated or operated in order to adjust a backrest inclination with respect to a seat pan.

The first fitting and the second fitting may be in the form of individual fittings which can be arranged separately from each other, in particular in a manner disassociated from each other. In other words, the first fitting and the second fitting can be decoupled from each other. This has the advantage that, to adjust the backrest from a first position into a second position, there is no need for a synchronization component between the first fitting and the second fitting for the rotary movement of the backrest. Synchronization between the two fittings, for example via a control unit and/or a coupling rod, is not necessary.

The first fitting and the second fitting may each comprise at least a first fitting part which can be mounted on a seat pan, in particular the seat pan frame, and a second fitting part which can be mounted on a backrest, in particular on a backrest frame, wherein the second fitting part is movable with respect to the first fitting part.

Each first fitting part may be welded to the seat pan frame and/or fastened thereto in some other way. Each second fitting part may be welded to the backrest frame and/or fastened thereto in some other way.

The first fitting part and the second fitting part may execute a relative rotary movement.

The first fitting part of the first fitting may be designed differently than the first fitting part of the second fitting. The first fitting part of the second fitting may, in particular, on account of its free swiveling function, have smaller dimensions than the first fitting part of the first fitting. It is also possible to provide a second fitting part for the second fitting with smaller dimensions.

The first fitting may be in the form of a fitting with manual actuation or of a fitting with force-actuated actuation. The first fitting may comprise a manual means or a force-actuated means, via which a multiplicity of use positions suitable for passenger transportation can thus be taken up.

The claimed seat for a vehicle comprises at least a seat pan frame, a backrest frame which is coupled to the seat pan frame in a swiveling manner, and a reclining mechanism for swivel-adjusting the backrest frame with respect to the seat pan frame between an upright use position and at least one reclined position.

The reclining mechanism for a seat, in particular a vehicle seat, comprises at least a first fitting which is able to be mounted on a first side of the seat, and an opposite second fitting which is able to be mounted on the second side of the seat, wherein each fitting has at least two fitting parts which are movable with respect to each other. The first fitting is an actuating fitting for actuating a swiveling movement between corresponding fitting parts of the first fitting, wherein the second fitting is a free swivel fitting which comprises at least one bushing unit which couples the corresponding fitting parts of the second fitting in order to enter into an eccentric movement caused by the first fitting.

As a result of the provision of a first fitting, which is an actuating fitting for actuating a swiveling movement between corresponding fitting parts of the first fitting, and the provision of a second fitting, which is a free swivel fitting, which comprises at least one bushing unit with which the corresponding fitting parts of the second fitting are coupled in order to enter into an eccentric movement caused by the first fitting, well-known double-sided force-actuated seat back adjusters can be replaced, with the result that the weight, the number of parts and costs are reduced. Furthermore, a slim and compact design of the seat and a small packaging space can be achieved.

The second fitting is a free swivel fitting, which follows a movement of the backrest when the latter is reclined upon actuation via the first fitting. Since only the first fitting is actuated, an actuation time can be reduced. The first fitting is a one-sided actuating fitting. The first fitting may be a one-sided force-actuated fitting, which is also referred to as a one-sided force-actuated seat back adjuster. The first fitting may optionally be manually actuated. Furthermore, no synchronization, for example via a control unit and/or a coupling rod, is required between the two fittings, thereby reducing costs, packaging space, the number of parts, and assembly time, and additionally simplifying the operation of the reclining mechanism.

The second fitting parts may each be mounted on an inner side of the backrest frame and the first fitting parts may be mounted on an outer side of the second fitting parts.

Further possible applications of the present invention will become clear from the following detailed description. It should be understood, however, that although the detailed description and the specific examples indicate preferred embodiments of the invention, they serve only for illustrative purposes since various changes and modifications in line with the concept of the invention and within the scope of the invention are obvious to those skilled in the art from this detailed description.

### DETAILED DESCRIPTION OF THE FIGURES

The present invention will become more comprehensively understood from the following detailed description and the accompanying drawings, which serve merely for illustrative purposes and therefore do not limit the present invention. In the drawings:

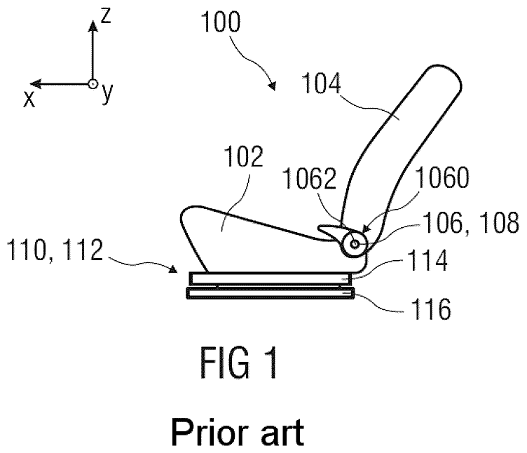

FIG. 1 shows a schematic illustration of a vehicle seat having a known height adjustment device,

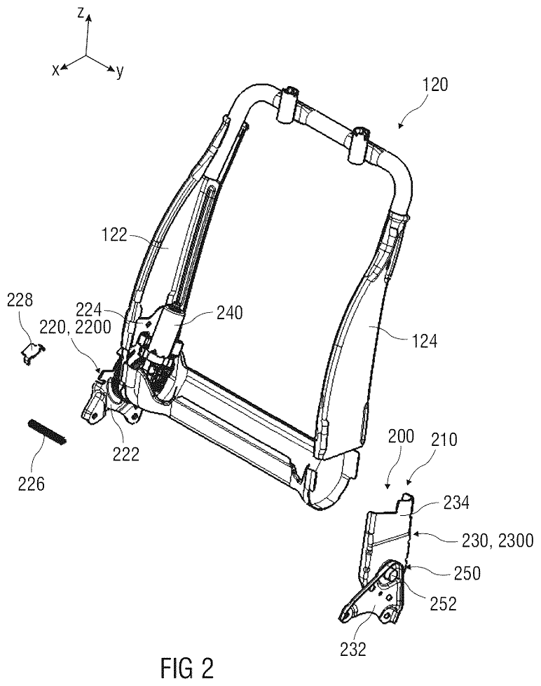

FIG. 2 shows a schematic, partially exploded view of a backrest frame having a reclining mechanism according to a first embodiment of the invention,

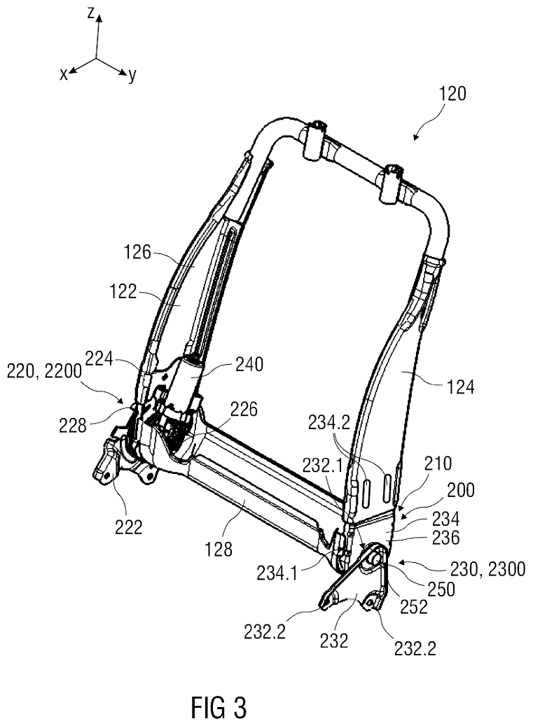

FIG. 3 shows a schematic perspective view of the backrest frame having a mounted reclining mechanism according to the first embodiment,

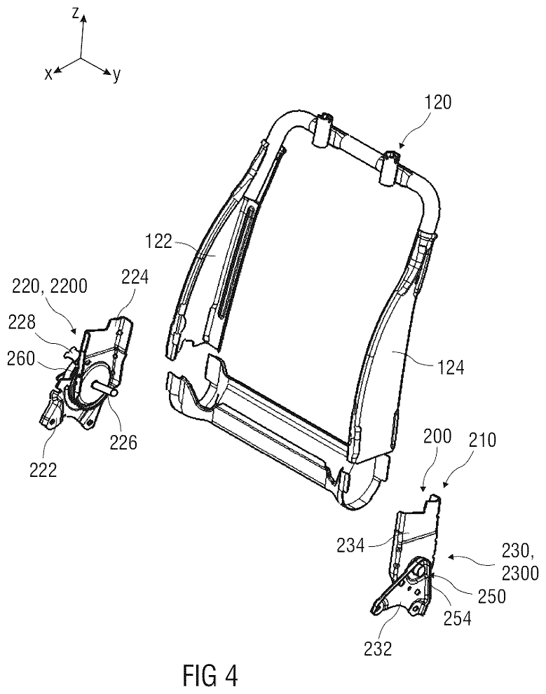

FIG. 4 shows a schematic, partially exploded view of a backrest frame having a reclining mechanism according to a second embodiment of the invention, and

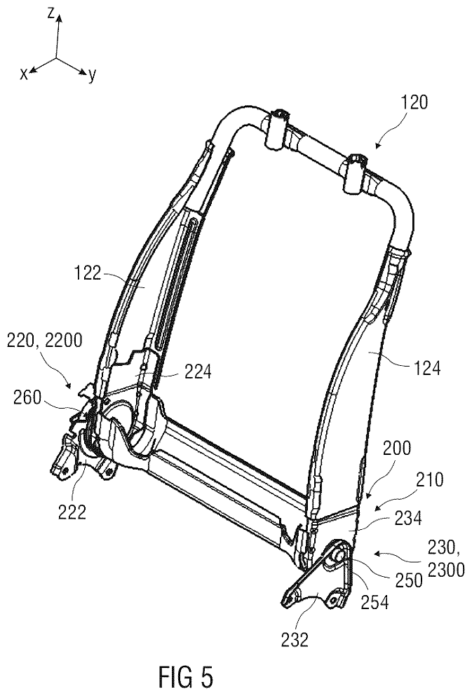

FIG. 5 shows a schematic perspective view of the backrest frame having a mounted reclining mechanism according to the second embodiment.

### DETAILED DESCRIPTION

Corresponding parts are provided with the same reference signs throughout the figures.

A known vehicle seat 100 schematically illustrated in FIG. 1 is described in the following text using three spatial axes or directions, which extend perpendicularly to each other. A longitudinal axis x extends horizontally and preferably parallel to a longitudinal direction of a vehicle with a vehicle seat 100 installed in the vehicle. The longitudinal direction corresponds to the usual direction of travel of the vehicle. A transverse axis y is likewise oriented horizontally in the vehicle and extends perpendicularly to the longitudinal direction and parallel to a transverse direction of the vehicle. A vertical axis z extends perpendicularly to the longitudinal direction and perpendicularly to the transverse direction. In the case of a vehicle seat 100 installed in the vehicle, the vertical axis z extends preferably parallel to a vehicle vertical direction.

The position indications and direction indications that are used, such as front, rear, top, and bottom, relate to a direction of view of an occupant who is sitting on the vehicle seat 100 in an upright sitting position such as a normal sitting position, wherein the vehicle seat 100 is installed in the vehicle in a use position suitable for transporting passengers with an upright backrest 104, wherein the vehicle seat 100 is oriented as usual in the direction of travel. The vehicle seat 100 may, however, also be installed or moved in a different orientation, for example transversely to the direction of travel. Unless described otherwise, the vehicle seat 100 is constructed mirror-symmetrically to a plane extending perpendicularly to the transverse direction y.

The position indications and direction indications that are used, such as radial, axial, and circumferential, relate to an axis of rotation 108 of the attachment device 106. Radial means perpendicular to the axis of rotation 108; axial means in the direction of or parallel to the axis of rotation 108.

The vehicle seat 100 may optionally comprise a longitudinal adjustment device 110. The longitudinal adjustment device 110 has, for example, a rail assembly 112 with a first rail element 114 and a second rail element 116. The first rail element 114 is adjustable in a longitudinal direction relative to the second rail element 116. The first rail element 114 is attached to the seat pan 102. The second rail element 116 is attached to a structural element of a vehicle, for example a vehicle floor.

For reasons of clarity, the first rail element 114 can be referred to as the upper rail 114. This upper rail 114 (which is also referred to as a running rail or a slide) is assigned to the vehicle seat 100 and designed to support the vehicle seat 100. The second rail element 116 can be referred to as the lower rail 116. The lower rail 116 is, for example, fastened to the floor of a vehicle and connected thereto.

The backrest 104 can be arranged in a swiveling manner on a seat pan 102 of the vehicle seat 100. For this purpose, the vehicle seat 100 can optionally comprise an attachment device 106 such as a seat back adjuster, in particular an adjustment fitting, swivel fitting or rotary fitting, catch fitting or latch fitting, or an eccentric fitting. Conventional attachment devices 106 have fitting units 1060 which are provided on both sides (in FIG. 1, only one is shown) and, with regard to unlocking, are mechanically coupled in particular by a rotatable transmission rod 1062 mounted on the seat 100 and bear the controller on the backrest 104. The two fitting units 1060 are designed for force actuation and are, for example, lockable continuous fitting units 1060. Conventionally, the fitting units 1060 each comprise an output pinion which can be driven by a drive motor provided on the backrest side, and the output pinion cooperates with a toothed segment that is attached in a rotationally fixed manner on a seat pan side, and a swiveling movement of the backrest 104 can be executed by the drive motor while the fitting units 1060 are unlocked.

FIG. 2 shows a schematic, partially exploded view of a backrest frame 120 with a reclining mechanism 200 according to a first embodiment of the invention.

The backrest frame 120 comprises at least two opposite backrest frame side parts 122, 124.

The reclining mechanism 200 comprises an attachment device 210 with a first fitting 220 which is arranged on one side of the backrest frame 120, and a second fitting 230 which is arranged on the other side of the backrest frame 120.

The backrest frame 120 according to the first embodiment is a one-sided force-actuated seat back adjuster backrest frame structure.

Each fitting 220, 230 has at least two fitting parts 222, 224, 232, 234, specifically a first fitting part 222, 232 and a second fitting part 224, 234, which are movable relative to each other.

The reclining mechanism 200 shown comprises a drive unit 240, which is coupled to the first fitting 220 and is fastened to a first backrest frame side part 122.

The first fitting 220 is an actuating fitting 2200 for actuating a release movement and swiveling movement between corresponding fitting parts 222, 224 of the first fitting 220. The first fitting 220 may comprise a drive unit 240. The second fitting 230 is a free swivel fitting 2300, which comprises at least one bushing unit 250, which couples the corresponding fitting parts 232, 234 of the second fitting 230 in order to enter into an off-center movement caused by the first fitting 220.

A conventional attachment device 106 can be retrofitted with the reclining mechanism 200 according to the invention, in order to reduce seat weight and packaging space. The backrest frame 120 may be a used part. The force-driven first fitting 220 may also be a used part.

The reclining mechanism 200 is designed in a modular manner. Each fitting 220, 230 of the reclining mechanism 200 is designed in a modular manner. As a result, the production and assembly are improved.

The bushing unit 250 may comprise the optional eccentric bushing 252. The first fitting 220 may be an off-center fitting. The first fitting 220 and the second fitting 230 are individual fittings 220, 230, which can be arranged separately from each other, in particular in a manner disassociated from each other. Conventionally used transmission rods 1062 between two fitting units 1060 are not required. Only the first fitting 220 needs a transmission shaft 226. Furthermore, the first fitting 220 can be equipped with a stop mount 228. The stop mount 228 can be arranged, for example, on the second fitting part 224 such that it is not contacted by a counterpart mount (not shown in more detail), which is arranged, for example, on the first fitting part 222, when the second fitting part 224 is adjusted from a first position into a second position. The stop mount 228 can be designed such that it projects from the second fitting part 224 for example in the widthwise direction. The swivel mount 228 may be in the form, for example, of a flap, a lug and/or an end stop.

FIG. 3 shows a schematic perspective view of the backrest frame 120 with a mounted reclining mechanism 200 according to the first embodiment.

The second fitting parts 224, 234 are arranged and mounted on a respective inwardly facing side 126 of the backrest frame 120. Each first fitting part 222, 232 is arranged and mounted on an outwardly facing side 236, in particular an outer-surface side, of each seat pan frame side part (not shown). The first fitting parts 222, 232 are coupled, on an outwardly facing side 236, to each respective second fitting part 224, 234.

The backrest frame 120 may comprise a lower frame structure 128 such as a shell structure 128, which connects the two backrest frame side parts 122, 124. The lower frame structure 128 may be arranged, for example, in a region between the two fittings 220, 230. The lower frame structure 128 may be attached, for example, to the two second fitting parts 224, 234.

The first fitting 220 may take up a locked and an unlocked state for reclining the backrest frame 120. Apart from actuation by the drive unit 240, provision can be made for manual adjustment via an adjustment device provided on the first fitting 220. The second fitting 230 is a free swivel fitting 2300, which follows a movement of the backrest frame 120 when it is reclined upon actuation via the first fitting 220. Since only the first fitting 220 is actuated, an actuation time can be reduced. The first fitting 220 is a one-sided force-actuated actuating fitting 2200.

The first fitting part 222 of the first fitting 220 is designed differently than the first fitting part 232 of the second fitting 230, wherein the first fitting part 232 of the second fitting 230 has smaller dimensions. The first fitting part 232 of the second fitting 230 is designed to be rotationally connected to the corresponding second fitting part 234. The fitting parts 232, 234 of the second fitting 230 are coupled together via the bushing unit 250. As a result, the first fitting part 232 of the second fitting 230 can be designed with smaller dimensions than the first fitting part 222 of the first fitting 220, this being necessary for the incorporation and support of release and adjustment components.

The first fitting part 232 of the second fitting 230 may be substantially V-shaped (inverted). The first fitting part 232 may be designed in a substantially triangular manner. The first fitting part 232 of the second fitting 230 may comprise an upper bushing guide 232.1. The first fitting part 232 may comprise two spaced-apart lower fastening elements 232.2, for example fastening holes and/or welding points, in order to fasten the first fitting part 232 to a seat pan frame. The corresponding second fitting part 234 may comprise a lower bushing guide 234.1 and upper fastening elements 234.2.

FIG. 4 shows a schematic, partially exploded view of a backrest frame 120 with a reclining mechanism 200 according to a second embodiment of the invention.

The reclining mechanism 200 is mounted analogously to the backrest frame 120 according to FIGS. 2 and 3. The reclining mechanism 200 is designed analogously to the first embodiment, except that the drive unit 240 has been omitted.

The reclining mechanism 200 comprises an attachment device 210 with a first fitting 220, which is arranged on one side of the backrest frame 120, and a second fitting 230, which is arranged on the other side of the backrest frame 120.

The backrest frame 120 according to the second embodiment is a one-sided manual seat back adjuster backrest frame structure. The reclining mechanism 200 is designed in a modular manner. Each fitting 220, 230 of the reclining mechanism 200 is designed in a modular manner. This improves production and assembly.

Each fitting 220, 230 has at least two fitting parts 222, 224, 232, 234, specifically a first fitting part 222, 232 and a second fitting part 224, 234, which are movable relative to each other.

The first fitting 220 is in the form of a manual actuating fitting 2200.

The bushing unit 250 may comprise an axial bushing 254. The first fitting 220 may be an off-center fitting. The first fitting 220 and the second fitting 230 are individual fittings 220, 230, which are arranged separately from each other, in particular in a manner disassociated from each other. The first fitting 220 comprises a transmission shaft 226, which couples the corresponding manual and force-actuated fitting parts 222, 224. Furthermore, the first fitting 220 comprises a swivel fitting 228. The stop mount 228 is arranged, for example, on the second fitting part 224 in order to be contacted by a counterpart mount (not shown in more detail) arranged, for example, on the first fitting part 222, when the second fitting part 224 is adjusted from a first position into a second position. The stop mount 228 can be designed such that it projects from the second fitting part 224 for example in the widthwise direction. The stop mount 228 may be in the form, for example, of a flap, a lug and/or an end stop. The first fitting 220 comprises a seat back adjuster core piece 260. The seat back adjuster core piece 260 may, when it is unlocked and actuated, allow unimpeded movement of the second fitting part 224 with respect to the first fitting part 222 from a first position into a second position. The actuation, unlocking and/or locking of the seat back adjuster core piece 260 can take place manually or in a force-actuated manner.

FIG. 5 shows a schematic perspective view of the backrest frame 120 with a mounted reclining mechanism 200 according to the second embodiment. The mounted state of the reclining mechanism 200 is analogous to the first embodiment according to FIG. 3.

The second fitting parts 224, 234 are arranged and mounted on a respective inwardly facing side 126 of the backrest frame 120. Each first fitting part 222, 232 is arranged and mounted on an outwardly facing side 236, in particular an outer-surface side, of each seat pan frame side part (not shown). The first fitting parts 222, 232 are coupled, on an outwardly facing side 236, to each respective second fitting part 224, 234.

The backrest frame 120 may comprise a lower frame structure 128 such as a shell structure 128, which connects the two backrest frame side parts 122, 124. The lower frame structure 128 may be arranged, for example, in a region between the two fittings 220, 230. The lower frame structure 128 may be attached, for example, to the two second fitting parts 224, 234.

The first fitting 220 may take up a locked and an unlocked state for reclining the backrest frame 120. The actuation of the first fitting 220 can be effected by the seat back adjuster core piece 260. The second fitting 230 is a free swivel fitting 2300, which follows a movement of the backrest frame 120 when it is reclined upon actuation via the first fitting 220. Since only the first fitting 220 is actuated, an actuation time can be reduced. The first fitting 220 is a one-sided manual actuating fitting 2200.

The second fitting parts 224, 234 can be designed as identical parts. The first fitting part 222 of the second fitting 220 is designed differently than the first fitting part 232 of the second fitting 230, wherein the first fitting part 232 of the second fitting 230 has smaller dimensions. The first fitting part 232 of the second fitting 230 is designed to be rotationally connected to the corresponding second fitting part 234. The fitting parts 232, 234 of the second fitting 230 are coupled together via the bushing unit 250. As a result, the first fitting part 232 of the second fitting 230 can be designed with smaller dimensions than the first fitting part 222 of the first fitting 220, this being necessary for the incorporation and support of release and adjustment components.

The first fitting part 232 of the second fitting 230 may be substantially V-shaped (inverted). The first fitting part 232 may be designed in a substantially triangular manner. The first fitting part 232 of the second fitting 230 may comprise an upper bushing guide 232.1. The first fitting part 232 may comprises two spaced-apart lower fastening elements 232.2, for example fastening holes and/or welding points, in order to fasten the first fitting part 232 to a seat pan frame. The corresponding second fitting part 234 may comprise a lower bushing guide 234.1 and upper fastening elements 234.2.

### LIST OF REFERENCE SIGNS

100 Seat
102 Seat pan
104 Backrest
106 Attachment device
1060 Fitting unit
1062 Rod
108 Axis of rotation
110 Longitudinal adjustment device
112 Rail assembly
114 First rail element (upper rail)
116 Second rail element (lower rail)
120 Backrest frame
122, 124 Side part of the backrest frame
126 Inwardly facing side
128 Structure
200 Reclining mechanism
210 Attachment device
220 First fitting
2200 Actuating fitting
222, 224 Fitting part
226 Shaft
228 Mount
230 Second fitting
2300 Free swivel fitting
232, 234 Fitting part
232.1 Bushing guide
232.2 Fastening element
234.1 Bushing guide
234.2 Fastening element
236 Outwardly facing side
240 Drive unit
250 Bushing unit
252 Eccentric bushing
254 Axial bushing
260 Seat back adjuster core piece
x Longitudinal axis
y Transverse axis
z Vertical axis

1. A reclining mechanism for a vehicle seat, wherein the reclining mechanism comprises:
a first fitting configured to be mounted on a first side of the seat, and
an opposing second fitting configured to be mounted on a second side of the seat,
wherein each fitting has at least two fitting parts that are movable relative to each other,
wherein the first fitting is an actuating fitting for actuating an eccentric swiveling movement between corresponding fitting parts of the first fitting, and
wherein the second fitting is a free swiveling fitting comprising at least one bushing unit which couples the corresponding fitting parts of the second fitting in order to absorb an eccentric movement caused by the first fitting, wherein the first fitting and the second fitting are designed as individual fittings that are decoupled from one another.

2. The reclining mechanism of claim 1, wherein the at least one bushing unit comprises an axial bushing.

3. The reclining mechanism of claim 1, wherein the at least one bushing unit comprises an eccentric bushing.

4. The reclining mechanism of claim 1, wherein the first fitting and the second fitting are arranged on the vehicle seat without synchronisation.

5. The reclining mechanism of claim 1, wherein the first fitting and the second fitting each comprise a first fitting part that can be mounted on a seat pan and a second fitting part that can be mounted on a backrest, wherein the second fitting part is movable relative to the first fitting part.

6. The reclining mechanism of claim 5, wherein the first fitting part of the first fitting is designed differently from the first fitting part of the second fitting, wherein the first fitting part of the second fitting has a smaller dimension.

7. The reclining mechanism of claim 1, wherein the first fitting is designed as a manual operating fitting or a power-operated fitting.

8. The reclining mechanism of claim 1, wherein the first fitting is designed as a swivel fitting, a bolt fitting or an eccentric fitting.

9. A seat for a vehicle, comprising:
a seat pan frame,
a backrest frame pivotally coupled to the seat pan frame, and
the reclining mechanism of claim 1;
wherein the reclining mechanism is configured for pivotally adjusting the backrest frame relative to the seat pan frame between an upright position of use and at least one reclined position.

10. The seat of claim 9, wherein the at least two fitting parts of the second fitting are each mounted on an inner side of the backrest frame and the at least two fitting parts of the first fitting parts are mounted on an outer side of the second fitting parts.

11. The seat of claim 9, wherein the first fitting is configured for a locked state and an unlocked state for reclining the backrest frame.

12. The seat of claim 9, wherein the second fitting is configured to follow a movement of the backrest frame when it is reclined upon actuation via the first fitting.

13. The seat of claim 9, wherein the reclining mechanism comprises a drive unit coupled to the first fitting.

14. The seat of claim 9, wherein the reclining mechanism comprises a drive unit fastened to the backrest frame.

15. The seat of claim 9, wherein the at least two fitting parts of the second fitting are mounted on an inwardly facing side of the backrest frame.

16. The reclining mechanism of claim 1, wherein the at least two fitting parts of the first fitting comprise a first fitting part and a second fitting part which are movable relative to one another.

17. The reclining mechanism of claim 1, wherein the at least two fitting parts of the second fitting comprise a first fitting part and a second fitting part which are movable relative to one another.
